(19) United States
(12) Patent Application Publication
(10) Pub. No.: US 2018/0015482 A1
(43) Pub. Date: Jan. 18, 2018

(54) ELECTROSTATIC AIR FILTER DESIGN AND ASSEMBLY

(71) Applicant: PACIFIC AIR FILTRATION HOLDINGS, LLC, Redmond, WA (US)

(72) Inventors: Larry Rothenberg, Boulder, CO (US); Alan Viosca, Seattle, WA (US); Igor Krichtafovitch, Kirkland, WA (US)

(73) Assignee: PACIFIC AIR FILTRATION HOLDINGS, LLC, Redmond, WA (US)

(21) Appl. No.: 15/653,440

(22) Filed: Jul. 18, 2017

Related U.S. Application Data
(60) Provisional application No. 62/493,819, filed on Jul. 18, 2016.

(51) Int. Cl. B03C 3/41; B03C 3/47

(52) U.S. Cl. CPC B03C 3/41; B03C 3/47; B03C 2201/04

(57) ABSTRACT

An electronic air filter containing two separate parts: an inlet part and an outlet part; an ionizer located in the inlet part; a collector located in the outlet part; the inlet part is detachable from the outlet part. The inlet part is a door. The outlet part contains detachable set of collecting electrodes.

### CROSS-REFERENCE AND RELATED APPLICATIONS

This application claims priority from and the benefit of the filing date of co-pending U.S. Provisional Application No. 62/493,819 filed on Jul. 18, 2016, the disclosure of which is expressly incorporated herein by reference in its entirety.

### BACKGROUND OF THE INVENTION

### 1. Field of the Invention

The present invention relates generally to cleaning gas flows using electrostatic air filters and associated systems and methods. In particular, several embodiments are directed toward electrostatic air filters that use light weight porous electrodes for dust collection.

### 2. Description of the Related Technology

Electrostatic air filters may comprise of one or two stages. Two-stage electrostatic air filters generally contain a corona electrode and an exciting electrode as ionization stage. The collecting electrodes and repelling electrodes constitute second stage which is a collecting stage. The collecting electrodes are commonly made to be plate-like, flat, or corrugated metal or electrically conductive plates. When sufficient electrical potential difference on the order of kilovolts or tens of kilovolts is applied between the corona and exiting electrodes, the corona discharge takes place and ions are emitted from the corona electrodes. These ions travel toward the collecting electrodes with an airflow produced by a fan or by an ionic wind. Dust particulates in the air become charged with the ions, and thus carry the electrical charge by themselves. When electrically charged particles reach the collecting electrodes, they settle there while clean air continues to pass further.

One of the biggest problems in electrostatic filters is an unwanted occasional electrical discharge between the electrodes. In fact, ASHRAE standard 52.2 stipulates air purifiers testing using carbon black, which contains an electrically conductive dust. In some industrial areas, most notoriously in China, so called “Asian dust” also carries dust that contains metal particles. After certain time of exposure to such dust, a conductive layer forms on the inter-electrode surfaces. The conductive layer may cause an electrical short between the electrodes.

Besides that, the electrodes removing, cleaning or replacement may became a tedious task in many cases. In particular, some users want to remove only collecting electrodes (where dust settles) and leave comparatively clean repelling electrodes in a case. That presents certain design challenges since currently accepted designs do not allow such partial removal.

Another challenge is an emitter wires cleaning. Due to high electric field strength near the emitter (corona) wires intense electro-chemical processes take part on the wire surface. As a result, chemicals and dust deposit on the wires and need to be removed by brushing them off for optimal performance. Current designs of the electrostatic filters do not allow easy and convenient cleaning of the emitter wires.

### SUMMARY OF THE INVENTION

According to an advantageous feature of the invention, the collecting electrode may include plate like flat members containing porous open cell media in which dust is trapped. Such porous media may collect much more dust than traditional metal collecting plates. Since it is light weight and not expensive material such porous media may be periodically disposed or, preferably, recycled.

Those flat members contain an inner flexible electrically conductive part and outer nonconductive parts made of porous open cell media. One of the examples of such open cell media is a melamine foam. The inner flexible part is “sandwiched” between flexible foam parts, which are also plate-like. The resulting “sandwich” may be supported by a rigid frame. The rigid frame with flexible sandwich forms a rigid collecting electrode assembly.

A number of such collecting electrode assemblies may be placed into a case having an air inlet and air outlet. The collecting electrodes may be placed into the air passage in such way that air passes along these collecting electrodes. A repelling plate-like electrode may be located between collecting electrodes. The repelling electrodes may be substantially parallel to the collecting electrodes. Together they form a collecting assembly.

On the upwind side of the collecting assembly the ionizer is located. It contains ion emitting (corona) electrode and, in some cases, so called exciting electrode.

First electric potential difference is applied between the collecting and repelling electrodes to push charged particles toward the collecting electrode. Second electric potential difference is applied between the ion emitting electrode and the exciting electrode. The second electric potential difference should be greater than corona onset voltage and less that breakdown voltage between the ion emitting and the exciting electrodes.

In conventional electrostatic air purifiers, all the electrodes with different electrical potential are attached to the common case walls and are separated by certain distance along those walls' surface. Once conductive dust is collected on the wall it may cause the electrical short between the electrodes, so called “creeping” discharge along the surface.

It is an object to reduce “creeping” discharge in electrostatic filters. This may be accomplished by configuring the stages as assemblies. A first assembly may be an ionizer. The ionizer may include an ion emitting electrode (corona wires) and an exciting electrode. The exciting electrode may be an air penetrable mesh, or one or more rods, or any air penetrable electrically conductive assembly located either upstream or downstream of the ion emitting electrode. The common features of the exciting electrode are: —it should be air penetrable with negligible pressure drop; —it should not emit ions back, i.e., should be made of rods thicker than wire or with closed mesh; and—if located upstream of the ion emitting electrode, it should have a distance between rods or mesh protecting the user from inserting fingers through it for safety reason.

The ionizer in the proposed invention may be attached to the case by a mounting structure. This mounting structure may be easily removable from the case or, preferably, located on a swinging door. The exciting electrode may be easily detachable for periodic cleaning and to allow access to the ion emitting wires for periodic cleaning and to facilitate cleaning or washing the exciting electrode. The important feature of ionizer assembly is that the ion emitting electrode and the exciting electrode are attached to the common case (or a swinging door) that is made of insulating material at an extended distance along the case or the door surface. The extended distance may be as near as practical to the maximum distance. If for instance the ion emitting electrode is secured on the horizontal surfaces (top and bottom) then the exciting electrode may be attached to the central part of these surfaces. In this event the exciting electrode may be attached to the vertical parts of the case (door) and is also secured at the central parts of it. In such design the distance between attachment points of the electrodes is maximized and prevents the electrical shortage between them.

The collecting assembly of the current invention also may include two separate assemblies. The first assembly may contain the repelling electrodes which may be secured to horizontal walls. The second assembly may contain collecting electrodes that are easily removable from the case. The collecting electrodes may be supported by two sets of brackets. A front set of brackets may be attached to the collecting electrodes from the inlet side. A back set of brackets may be attached to the case vertical walls from the outlet side. The case vertical walls may have rails for guiding front brackets into the case when the collecting electrodes (second assembly) are inserted.

During the device manufacturing the collecting electrodes may be first attached to the front brackets. Front brackets with the collecting electrodes attached to them may form a sub-assembly set. The sub-assembly set may be inserted into the case along the rails until it meets the back brackets. After the sub-assembly is fully inserted into the case front and back brackets together with collecting electrodes form the full second assembly that is supported by the vertical walls.

Such design practically maximizes the distance between the repelling and collecting electrode attachment points at vertical and horizontal walls. It would be advantageous for the electrostatic air filter that the inner sides of the walls is protected from the dust contamination. That may be achieved by blocking air passage along these walls, or by directing air away from the walls by air deflectors, or by charging the walls with the same electrical polarity as dust particles are charged by the ionizer.

It was experimentally determined that inlet parts of the collecting electrodes collect more dust than the tail parts of the same electrodes. Therefore, the electrodes are usually replaced when only front part is fully contaminated. In order to extend the electrodes time between services/replacement it would be advantageous to remove the collecting electrodes after front part is fully contaminated, then rotate them so that tail parts will take a place of front parts. After that the electrodes with front brackets may be re-inserted into the case. In practice that near doubles the life of the collecting electrodes.

The repelling electrodes also collect some amount of dust and require periodic albeit less frequent cleaning. In order to facilitate the repelling electrodes cleaning it would be advantageous to secure them to removable part of the case such as bottom wall, or a vertical wall, or to both.

It is also advantageous to make all high voltage (“HV”) cables and wires as short as possible. First, it makes the device cost efficient because HV cable are costly. Second, HV cable are the main source of electromagnetic interference. The longer they are the greater electromagnetic signal they can generate in case of spark or another undesirable event. In order to shorten HV cables to minimum possible length the High Voltage Power Supply (HVPS) should be located as close to the electrodes as possible. It is advantageous to put all HV and other electronics parts and components into one compartment. When employing Switch Mode Power Supplies such electronics is compact and may be placed near all the electrodes. The routes from the HVPS to the all electrodes should be also the shortest one possible.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows the schematics of an electrostatic air filter.

FIG. 2 shows the schematics of an electrostatic air filter with a front door open.

FIG. 3 shows the schematics of an electrostatic air filter with a collecting electrodes pre-assembly removed.

FIG. 4 shows the schematics of a blow-out view of an electrostatic air filter.

### DETAILED DESCRIPTION OF THE PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

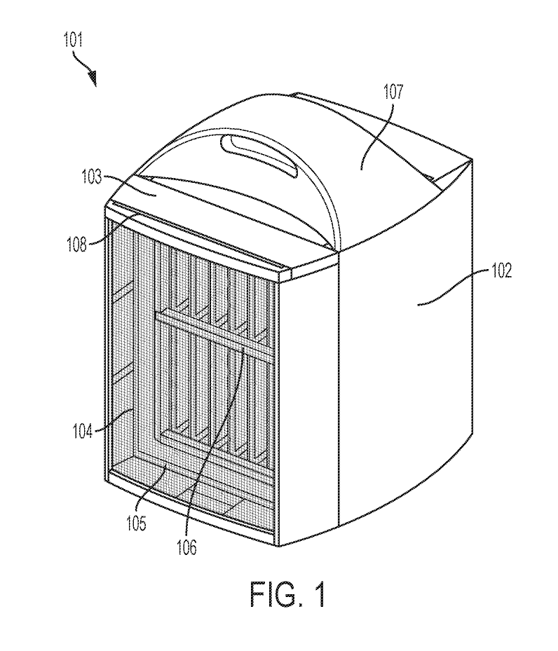

Referring to FIG. 1, the proposed electrostatic air filter 101 is schematically shown. It contains a case 102 with the ionizer 103 located in the door and the collecting assembly 106 located behind the door. The emitting wires 105 and the exciting mesh-like electrodes 104 constitute an ionizer 103. The ionizer 103 is secured in the inlet door. The exciting electrode 104 is inserted via a slot 108. The exciting electrode 104 (which is preferably earth grounded) may be easily removed through the slot 108 for periodic cleaning. The handle 107 is located on the top of the electrostatic air filter 101. Inside of the handle 107 HVPS and controller electronics are located. HV cables (not shown) are located in a proximity of the electrodes. Due to close proximity the HV cables are short and, in some cases may be replaced with low voltage cables or even bare wires since they do not cross path with low voltage cables.

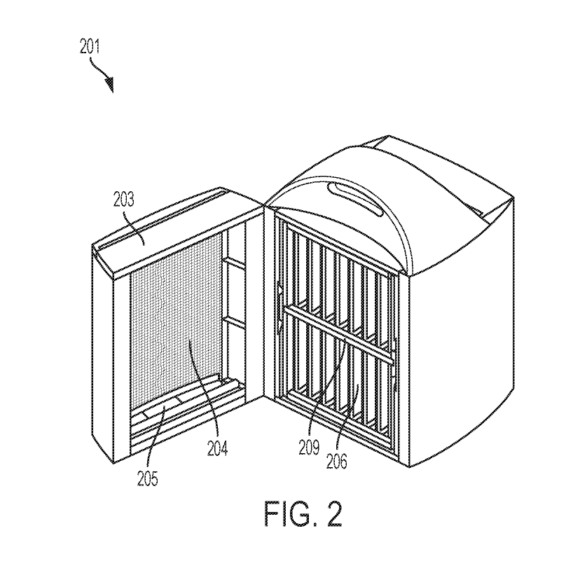

FIG. 2 shows the same electrostatic air filter 201 with the ionizing assembly 203 open (as an inlet door). The exciting mesh-like electrode 204 is also exposed. The exciting electrode 204 may be located at the upwind or on the downwind side of the ion emitting wires 205 or on both sides of it. The collecting electrodes 206 are also expose here. The front brackets 209 on which the collecting electrodes are secured are also shown here.

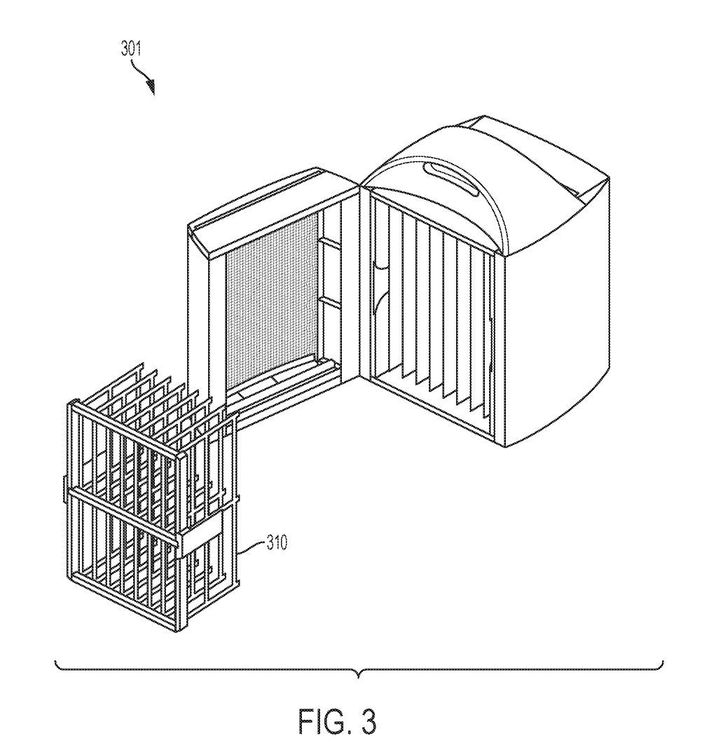

FIG. 3 shows the same electrostatic air filter 301 with the door open and the collecting electrodes pre-assembly 310 removed. The pre-assembly may be rearranged in the way that the collecting electrodes are inverted. After the inversion the collecting electrode] plate's front edge will be placed at the back. The front edges of the collecting electrodes are usually dirtier than tail edges. Therefore, relatively clean tail edges being placed in front may be used for a long time. That increases the electrodes time between replacement and decreases overall operating expenses.

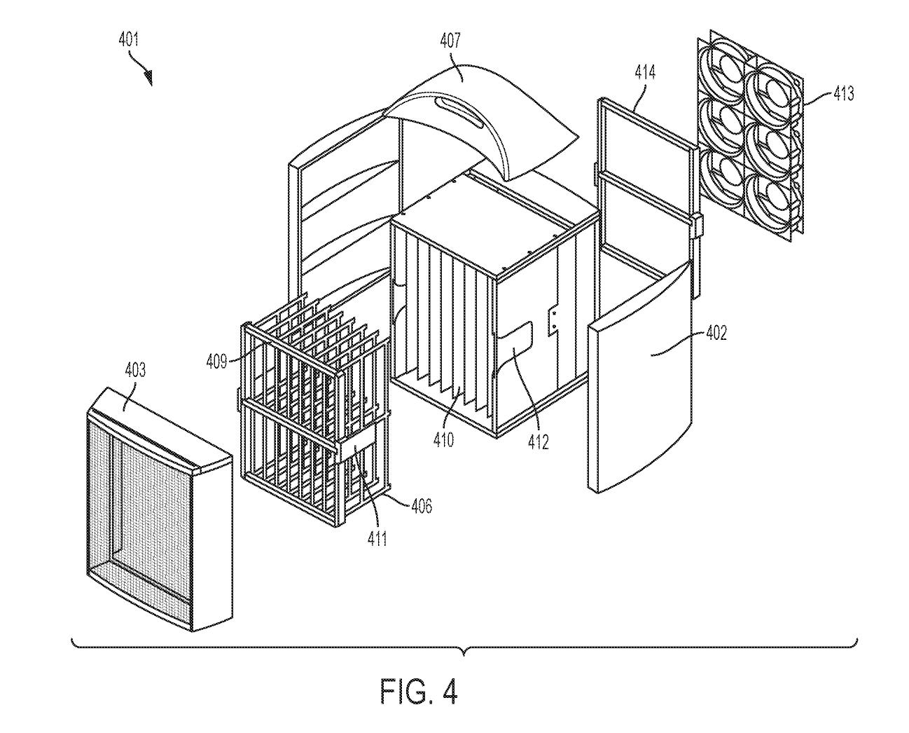

FIG. 4 shows the same electrostatic air filter 401 in exploded view. It contains the ionizer 403. The collecting electrodes pre-assembly consists of the collecting electrodes 406, the front brackets 409 with the rail 411. When the collecting electrodes pre-assembly is inserted into the case, the rails 411 are sliding along the slots 412. When the collecting electrodes pre-assembly is fully inserted the collecting electrodes tails are supported and secured by the back bracket 414. The repelling electrodes are secured on the horizontal walls of the case (top and bottom). The electrostatic air filter 401 also contains the top lid 407 with electronics hidden inside and the fans 413 at the air outlet.

Thus, the specific systems and methods for the electrostatic air filter have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “contains” and “containing” should be interpreted as referring to members, or components in a non-exclusive manner, indicating that the referenced elements and components, may be present, or utilized, or combined with other members and components that are not expressly referenced.

1. An electrostatic air filter comprising:
a case having an inlet part and an outlet part;
an ionizer located in the inlet part of said case;
a collector located in the outlet part of said case; and
wherein said inlet part of said case is detachable from said outlet part of said case.

2. The electrostatic air filter according to claim 1, wherein said case comprises a housing section and a door attached to said inlet part is mounted on said door.

3. The electrostatic air filter according to claim 1, wherein said ionizer further comprises an ion emitter and an exciting electrode.

4. The electrostatic air filter according to claim 3, wherein said ion emitter comprises a set of thin wires suspended on a frame;
said exciting electrode further comprises an electrically conductive mesh;
wherein said frame and said mesh are suspended at one or more exciting electrode mounting points to the inlet part walls;
wherein said frame is mounted at one or more mesh mounting points at the inlet part walls;
wherein said exciting electrode mounting points and said mesh mounting points and said exciting electrode mounting points are spaced from each other a substantially maximized surface distance from said conductive mesh suspending points.

5. The electrostatic air filter according to claim 1, wherein said collector further comprises collecting electrodes and plate-like repelling electrodes essentially parallel to each other and also to the principal direction of the air flow.

6. The electrostatic air filter according to claim 5, further comprising a removable substrate and wherein said collecting electrodes are attached to said removable substrate.

7. The electrostatic air filter according to claim 6, wherein said removable substrate further comprises one or more brackets supporting said collecting electrodes from an inlet side.

8. The electrostatic air filter according to claim 7, wherein said brackets are supported by a rail located at the substantially maximum surface path from the repelling electrodes attachment points.

9. The electrostatic air filter according to claim 5, wherein said collecting electrodes further comprises plate-like flat members containing inner flexible electrically conductive part and outer nonconductive parts consisting of porous open cell media.
